(19) United States
(12) Patent Application Publication
(10) Pub. No.: US 2006/0084570 A1
(43) Pub. Date: Apr. 20, 2006

(54) System and method for growing nanostructures from a periphery of a catalyst layer

(76) Inventors: Thomas E. Kopley, La Honda, CA (US); Jennifer Lu, Milpitas, CA (US); Nicolas J. Moll, Woodside, CA (US); Sungsoo Yi, Sunnyvale, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/035,595

(22) Filed: Jan. 14, 2005

Related U.S. Application Data
(60) Provisional application No. 60/612,042, filed on Sep. 21, 2004.

(51) Int. Cl. B01J 21/04

(52) U.S. Cl. 502/325; 502/439

(57) ABSTRACT

Systems and methods are provided for limiting the growth of nanostructures, such as nanotubes, from a catalyst layer. More particularly, systems and methods are provided for growing nanostructures from the periphery of a catalyst layer. In certain embodiments, a catalyst layer from which nanostructures can be grown during a growth process, such as CVD or PECVD, is located on a substrate. The catalyst layer is covered with a covering layer such that the catalyst layer is sandwiched between the substrate and the covering layer. The resulting structure then undergoes a nanostructure growth process. Because the catalyst layer is sandwiched between the substrate and the covering layer, growth of nanostructures is limited to growth from nanoparticles located on the periphery of the catalyst layer. Thus, growth of nanostructures does not result from nanoparticles located in an interior region of the catalyst layer.

### CROSS-REFERENCE TO RELATED APPLICATIONS

This application claims priority to U.S. Provisional Patent Application Ser. No. 60/612,042 entitled “Carbon Nanotube Catalyst Patterning and Carbon Nanotube Growth from the Edge of a Patterned Thin Film”, filed Sep. 21, 2004, the disclosure of which is hereby incorporated herein by reference.

### BACKGROUND OF THE INVENTION

Carbon nanotubes (CNTs) have become the most studied structures in the field of nanotechnology due to their remarkable electrical, thermal, and mechanical properties. In general, a carbon nanotube can be visualized as a sheet of hexagonal graph paper rolled up into a seamless tube and joined. Each line on the graph paper represents a carbon-carbon bond, and each intersection point represents a carbon atom. In general, CNTs are elongated tubular bodies which are typically only a few atoms in circumference. The CNTs are hollow and have a linear fullerene structure. Such elongated fullerenes having diameters as small as 0.4 nanometers (nm) (Nature (408), pgs. 50-51, November 2000) and lengths of several micrometers to tens of millimeters have been recognized. Both single-walled carbon nanotubes (SWCNTs) and multi-walled carbon nanotubes (MWCNTs) have been recognized.

CNTs have been proposed for a number of applications because they possess a very desirable and unique combination of physical properties relating to, for example, strength and weight ratio. For instance, CNTs are being considered for a large number of applications, including without limitation field-emitter tips for displays, transistors, interconnect and memory elements in integrated circuits, scan tips for atomic force microscopy, and sensor elements for chemical and biological sensing. CNTs are either conductors (metallic) or semiconductors, depending on their diameter and the spiral alignment of the hexagonal rings of graphite along the tube axis. They also have very high tensile strengths. See Saito, R., et al., Physical Properties of Carbon Nanotubes, Imperial College Press, London (1998); Springer: New York, 2001; Vol. 80. CNTs have demonstrated excellent electrical conductivity. See e.g. Yakobson, B. I., et al., American Scientist, 85, pg. 324-337 (1997); and Dresselhaus, M. S., et al., Science of Fullerenes and Carbon Nanotubes, 1996, San Diego: Academic Press, pp. 901-908. 902-905. For example, CNTs conduct heat and electricity better than copper or gold and have 100 times the tensile strength of steel, with only one-sixth of the weight of steel.

Various techniques for producing CNTs have been developed. The early processes used for CNT production were laser ablation and an arc discharge approach. More recently, chemical vapor deposition (CVD) is becoming widely used for growing CNTs. In this approach, a feedstock, such as CO or a hydrocarbon or alcohol, is heated (e.g., to 600-1000° C.) with a transition metal catalyst to promote the CNT growth. Even more recently, plasma enhanced CVD (PECVD) has been proposed for use in producing CNTs, which may permit their growth at lower temperatures, see e.g., Meyyappan, M. et al., “Carbon nanotube growth by PECVD: a review,” Plasma Sources Sci. Technology 12, pg. 205-216 (2003). Thus, in several production processes, such as CVD and PECVD, CNTs can be grown from a catalyst on a substrate surface, such as a substrate (e.g., silicon or quartz) that is suitable for fabrication of electronic devices, sensors, field emitters and other applications. For instance, using techniques as CVD and PECVD, CNTs can be grown on a substrate (e.g., wafer) that may be used in known semiconductor fabrication processes. In general, the catalyst includes nanoparticles therein from which nanotubes grow during the growth process (i.e., one nanotube may grow from each nanoparticle).

CNT growth using transition-metal catalyst nanoparticles in a CVD system has become the standard technique for growth of single-wall and multi-wall CNTs for substrate-deposited applications, see e.g., Meyyappan, M. et al., “Carbon nanotube growth by PECVD: a review,” Plasma Sources Sci. Technology 12, pg. 205-216 (2003). Various catalyst systems have been developed for CVD growth, including iron/molybdenum/alumina films (see e.g., M. Su et al., “Lattice-Oriented Growth of Single-Walled Carbon Nanotubes,” J. Phys. Chem. B 104(28), p. 6505 (2000)), iron nanoparticles formed with ferritin (see e.g., Y. Li et al., “Growth of Single-Walled Carbon Nanotubes from Discrete Catalytic Nanoparticles of Various Sizes,” J. Phys. Chem. B 105, p. 11424 (2001)), nickel/alumina films (see e.g., R. Y. Zhang et al., “Chemical Vapor Deposition of Single-Walled Carbon Nanotubes Using Ultrathin Ni/Al Film as catalyst,” Nano Lett. 3(6), p. 731 (2003)), cobalt-based catalyst films, and self-assembled arrays of nanoparticle catalysts formed using diblock copolymers (J. Raez et al., “Self-assembled organometallic block copolymer nanotubes,” Angewandte Chemie 39(21), p 3862-3865 (2000)).

Key to many applications is the control of CNT placement on a substrate. However, handling of CNTs is generally cumbersome, resulting in difficulty in post-processing of CNTs (after they are grown) to control/modify their placement on a substrate. Thus, it becomes desirable to control the placement of CNTs on a substrate during their growth. For instance, by controlling the placement of the as-grown nanotubes, such nanotubes may be grown to achieve a placement desired for a given application. Generally, CNTs grow in an uncontrolled, somewhat random manner from a catalyst. Certain techniques are known to influence the direction of growth of nanotubes. Examples of such techniques for influencing the direction of nanotube growth include application of electric fields (either external to or arranged locally on the substrate), blowing gas in a certain direction, a directed ion stream, control of carbon gas density gradient during growth (which may influence in what direction the tubes grow, i.e., they should grow along the carbon gradient). However, typically a nanotube grows from each of the nanoparticles included in a catalyst layer. Thus, for example, a catalyst layer may be implemented as a thin film that is spun on a substrate and that includes nanoparticles therein from which nanotubes can be grown. Due to the densely populated nanoclusters in a catalyst thin film, many nanotubes grown from this catalyst layer may intertwine.

To aid in controlling placement of CNTs grown on a substrate, techniques to pattern catalyst layers on substrate surfaces have also been proposed, see e.g., J. Kong et al., “Synthesis of individual single-walled carbon nanotubes on patterned silicon wafers,” Nature 395, p. 878 (1998). In another technique, self-assembled arrays of nanoparticles formed using diblock copolymers have been confined to patterned trenches on a substrate, see e.g., J. Y. Cheng et al., “Templated Self-Assembly of Block Copolymers: Effect of Substrate Topology,” Adv. Mater. 15(19), p. 1599 (2003). While such techniques may be scaled to smaller dimensions using advanced lithography techniques such as electron-beam lithography, they cannot easily reach the ultimate control of a single nanoparticle or even a single row of nanoparticles in a catalyst, which could be very useful for various applications. An undesirably dense population of nanoparticles may be present in even a patterned catalyst layer, thus resulting in many nanotubes growing from the patterned catalyst layer. Thus, there is a need for a method for providing finer control of nanoparticle catalysts for CNT growth.

### BRIEF SUMMARY OF THE INVENTION

Embodiments of the present invention provide systems and methods for limiting the growth of nanostructures, such as nanotubes, from a catalyst layer. More particularly, systems and methods are provided for growing nanostructures from a periphery of a catalyst thin film. The concepts provided herein are not limited in application to growth of nanotubes, but may likewise be utilized for controlling the growth of other nanostructures (particularly those having high aspect ratios), such as nanofibers, nanoribbons, nanothreads, nanowires, nanorods, nanobelts, nanosheets, and nanorings, as examples.

In certain embodiments, a catalyst layer is located on a substrate. For instance, a thin film catalyst layer may be spun onto a substrate. Such catalyst layer includes any catalyst now known or later developed for growing nanostructures, including, as examples, an iron/molybdenum/alumina film, iron nanoparticles formed with ferritin, a nickel/alumina film, a cobalt-based catalyst film, and a self-assembled array of nanoparticle catalysts formed using diblock copolymers. The catalyst layer is covered with a covering layer. Thus, the catalyst layer is sandwiched between the substrate and the covering layer, resulting in a sandwich structure. The resulting structure then undergoes a nanostructure growth process, such as a CVD or PECVD process. Because the catalyst layer is sandwiched between the substrate and the covering layer, growth of nanostructures is limited to growth from nanoparticles located on the periphery of the catalyst layer. Thus, growth of nanostructures does not result from nanoparticles located in an interior region of the catalyst layer.

It should be understood that as used herein, except where otherwise qualified with accompanying language, the term “periphery” broadly refers to at least some portion of an outward region of the catalyst layer, as opposed to an internal region of the catalyst layer. The periphery need not refer to the entire perimeter about the catalyst layer, but may instead be the outward region on only one or more sides of the catalyst layer's perimeter. Further, the outward region of the catalyst layer is not limited to the exact edge (or “outer boundary”) of the catalyst layer, but is instead intended to encompass a region of the catalyst layer adjacent the catalyst layer's outer edge that is sufficiently exposed to the environment to enable growth of nanostructures from nanoparticles contained in such region during a growth process, such as CVD or PECVD.

As a relatively simple example for illustrative purposes, a catalyst layer may be a rectangular thin film that contains nanoparticles distributed throughout, wherein certain nanoparticles reside in an internal region of the rectangular thin film and certain nanoparticles reside about the periphery of the rectangle. The rectangular thin film is sandwiched between a substrate and a covering layer such that only the periphery of the thin film is exposed during a nanostructure growth process, such as CVD or PECVD. As such, nanostructures grow only from those nanoparticles residing about the periphery of the thin film. Nanostructures do not result from the nanoparticles residing in the internal region of the thin film (e.g., the center of the rectangle), as those nanoparticles are shielded from the nanostructure growth process by the substrate and covering layer.

Of course, in certain implementations, the nanostructures may not grow about the full periphery (i.e., the entire perimeter) of the thin film. For instance, continuing with the above example, in certain implementations one or more sides of the rectangular thin film are shielded. For example, the covering layer may surround one or more sides of the rectangular thin film such that the covering layer engages the substrate on one or more sides of the rectangular thin film. Thus, in this instance, nanostructures will grow from the exposed portions of the catalyst layer's periphery, i.e., those sides of the rectangular thin film that are not surrounded by the covering layer.

### BRIEF DESCRIPTION OF THE DRAWINGS

FIG. 1 shows an exemplary apparatus from which nanostructures may be grown in accordance with one embodiment of the present invention;

FIG. 2 shows the exemplary apparatus of FIG. 1 after it is subjected to a nanostructure growth process;

FIGS. 3A-3D show an exemplary fabrication process according to one embodiment of the present invention;

FIG. 4 shows the exemplary structure of FIG. 3D that results when the catalyst layer is patterned to remove both rows and columns;

FIG. 5 shows the exemplary apparatus of FIG. 4 after it is subjected to a nanostructure growth process;

FIG. 6 shows a flow diagram for an exemplary method for limiting the number of nanostructures that are grown from a catalyst layer according to one embodiment of the present invention; and

FIG. 7 shows a flow diagram for another exemplary method for limiting the number of nanostructures that are grown from a catalyst layer according to one embodiment of the present invention.

### DETAILED DESCRIPTION OF THE INVENTION

According to one embodiment of the present invention, a thin film catalyst layer is deposited on a substrate, e.g., a wafer, and then a covering layer is deposited on the thin film catalyst layer. The covering layer and thin film catalyst layer are then patterned, e.g., using known lithographic etching and/or lift-off techniques, to form a desired shape of the catalyst layer and covering layer, such as the above-described rectangular thin film catalyst layer, that is located at a desired location on the substrate. As such, only the periphery of the thin film catalyst layer is exposed between the covering layer and the substrate. The nanostructure growth process, e.g., CVD or PECVD, is then performed on this structure, which results in nanostructures growing from the nanoparticles located at the exposed periphery of the thin film catalyst layer. Thus, the population of nanostructures growing from the catalyst layer is limited.

Further, in certain embodiments, the thin film catalyst layer is patterned to further limit the density of the nanostructures that are grown therefrom. For instance, according to one embodiment, a thin film catalyst layer is deposited on a substrate, e.g., a wafer, and then such thin film catalyst layer is patterned to remove nanoparticles therefrom. For example, the thin film catalyst layer may be patterned to remove one or more rows and/or columns of nanoparticles therefrom, thus resulting in a less dense population of nanoparticles at the catalyst layer's periphery. The patterning may result in an increase in spacing between the nanoparticles remaining about the catalyst layer's periphery. A covering layer is then deposited on the thin film catalyst layer, and such covering layer may be patterned such that it resides on the top of the thin film catalyst layer but does not surround the outer edges of the thin film catalyst layer. It should be noted that this occurs naturally when one patterns the covering layer and catalyst layer together. As such, only the periphery of the thin film catalyst layer is exposed between the covering layer and the substrate. The nanostructure growth process (e.g., CVD or PECVD) is then performed on this structure, which results in nanostructures growing from the nanoparticles located at the exposed periphery of the thin film catalyst layer. Thus, the population of nanostructures growing from the catalyst layer is further limited, and such nanostructures are spaced about the catalyst layer's periphery in a desired manner.

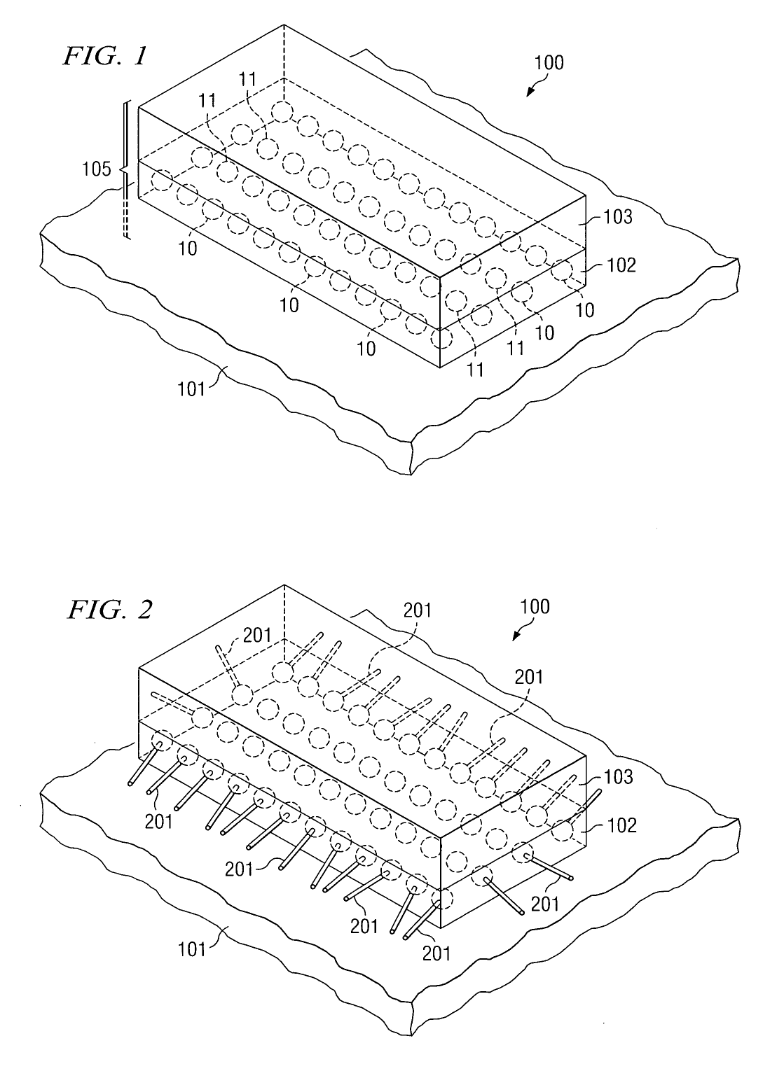

Turning to FIG. 1, an exemplary apparatus 100 from which nanostructures may be grown in accordance with one embodiment of the present invention is shown. In this example, apparatus 100 includes substrate 101, catalyst layer 102, and covering layer 103. Catalyst layer 102 includes nanoparticles therein, which if exposed to a nanostructure growth process (e.g., CVD or PECVD) result in growth of nanostructures. Examples of known nanoparticles that may be included in catalyst layer 102 for growing nanotubes, for instance, include catalyst and co-catalyst nanoparticles such as Fe, Co, Ni, Fe/Mo, Co/Mo, and Fe/Pt. As shown, catalyst layer 102 is located between substrate 101 and covering layer 103, forming sandwich structure 105, such that nanoparticles 10 located at the periphery of such catalyst layer 102 are exposed to the growth process and nanoparticles 11 located in an internal region of catalyst layer 102 are shielded from the growth process. Accordingly, when apparatus 100 is subjected to a nanostructure growth process, nanostructures, such as nanotubes, will grow from nanoparticles 10 about the periphery of catalyst layer 102, but nanostructures will not grow from the shielded nanoparticles 11.

FIG. 2 shows exemplary apparatus 100 after it is subjected to a nanostructure growth process. In this illustrated example, nanotubes 201 have grown from nanoparticles 10 about the periphery of catalyst layer 102. Because the catalyst layer 102 is sandwiched between the substrate 101 and the covering layer 103 in the sandwich structure 105, growth of nanotubes 201 is limited to growth from nanoparticles 10 located on the periphery of the catalyst layer 102. Thus, growth of nanotubes does not result from nanoparticles 11 located in the shielded interior region of the catalyst layer 102. Accordingly, the population of nanotubes growing from the catalyst layer 102 is limited, which may be desirable for many applications.

Exemplary apparatus 100 of FIG. 1 may be formed in a number of ways. As one example, catalyst layer 102 is a thin film that is deposited on substrate 101. After catalyst layer 102 is deposited on substrate 101, covering layer 103 is deposited on top of catalyst layer 102. There may be several steps performed after the catalyst layer deposition and before the deposition of covering layer 103. These steps may, for example, aid in catalyst preparation for growth of the desired nanostructure (e.g., CNTs) and are unique for each catalyst system used. After deposition of all layers, the thin film catalyst layer 102 is patterned using standard lithographic techniques, such as photolithography or electron-beam lithography. While the covering material 103 and catalyst layer 102 are patterned into a rectangular shape in the exemplary apparatus 100, embodiments of the present invention are not so limited. Instead, covering material 103 and catalyst layer 102 may be patterned into any desired shape.

While relatively few nanoparticles are shown as included in catalyst layer 102 for ease of illustration in FIGS. 1 and 2, many more of such nanoparticles may be included in catalyst layer 102 in actual implementations. Further, while nanoparticles 10 and 11 are shown arranged in rows and columns in FIG. 1, such nanoparticles may have a different distribution within catalyst layer 102. For example, Iron-Molybdenum catalyst particles on an alumina support matrix will be randomly distributed in the catalyst layer, while any catalyst particle (Fe, Co, Ni, or any of their alloys with Mo) deposited with a diblock copolymer will have a short-range (<˜1 μm) cubic or hexagonal symmetry. Thus, while shown and described as being arranged in rows and columns in the examples herein, in actual implementations the nanoparticles from which nanostructures (e.g., nanotubes) grow will likely not be arranged in perfect rows and columns. However, some degree of symmetry in the arrangement of nanoparticles may exist, at least over a short-range, in the catalyst layer. Even if the nanoparticles are arranged in a spatially periodic pattern, it would be difficult to orient the lithography to the pattern to take out select rows and/or columns. However, the techniques described herein provide for an effective technique for limiting the growth of nanotubes to the periphery of a catalyst layer. Further, as described below, in certain embodiments the catalyst layer may be patterned to further limit the number and/or modify the spacing/density of the nanoparticles that reside about the periphery of such catalyst layer.

The exemplary embodiment of FIGS. 1 and 2 allows limited nanoparticle(s) in a given row/column of catalyst layer 102 to be exposed during a nanostructure growth process for growing a nanostructure (e.g., nanotube) therefrom. For instance, only those nanoparticles of rows/columns that reside at the exposed periphery of the catalyst layer will grow nanostructures during a growth process.

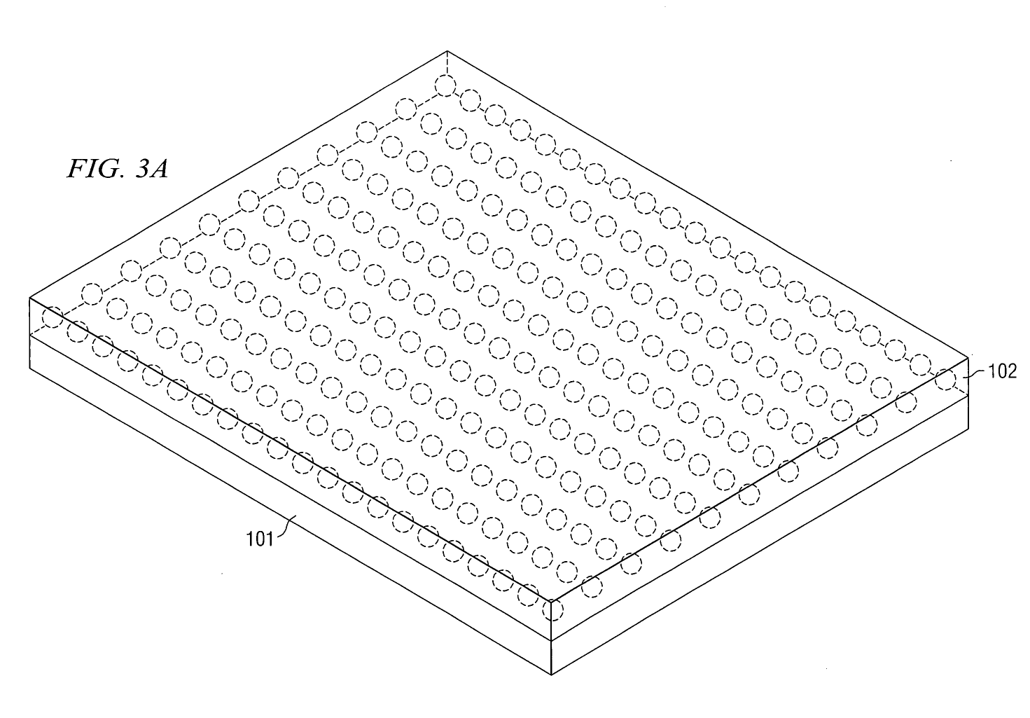

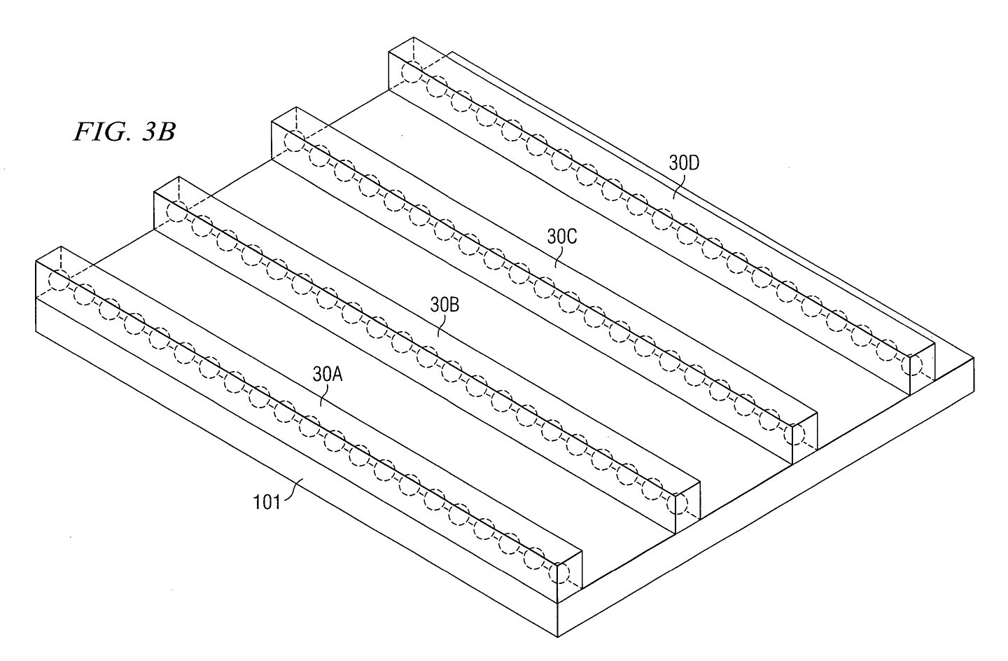

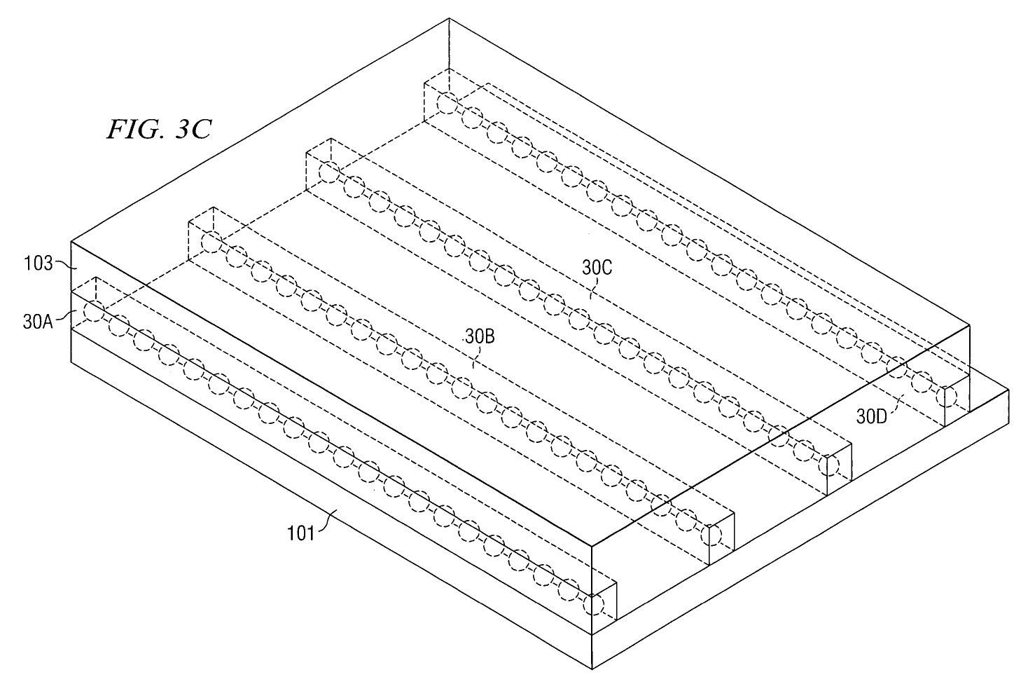

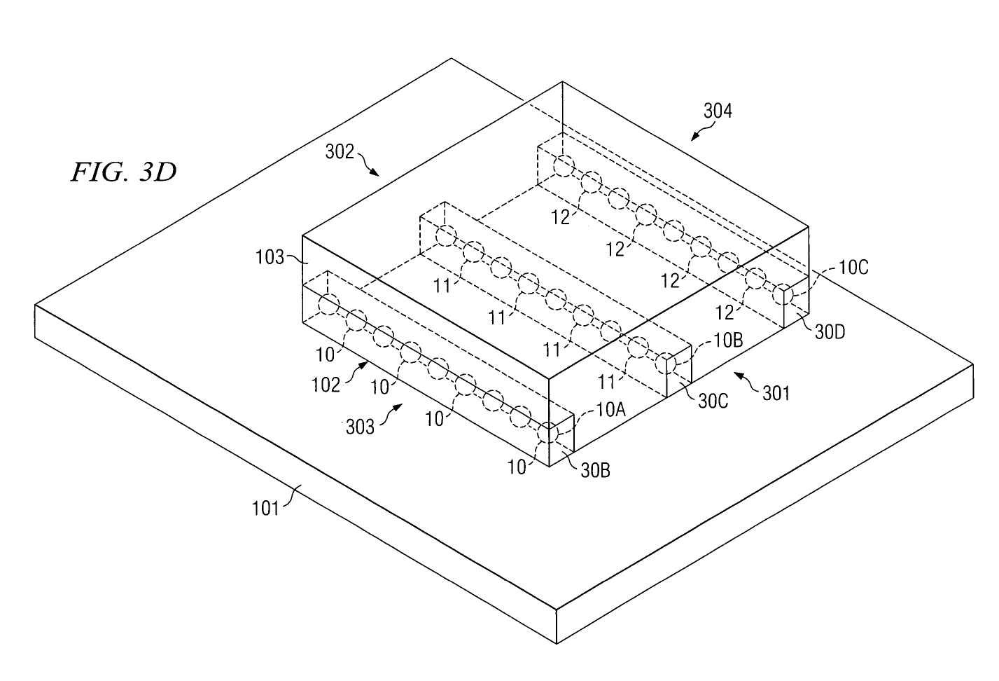

In certain embodiments, the catalyst layer 102 may be patterned before deposition of covering layer 103 in order to further limit the number of nanostructures to be grown therefrom and/or to control relative spacing of the nanostructures to be grown from the catalyst layer. FIGS. 3A-3D show an exemplary fabrication process according to one embodiment of the present invention. As shown in FIG. 3A, catalyst layer 102 is deposited on substrate 101. As described above, catalyst layer 102 may be a thin film that contains nanoparticles from which nanostructures (e.g., nanotubes) may be grown, and such thin film may be spun onto substrate 101. As shown in FIG. 3A, the initial deposition of catalyst layer 102 covers the entire surface of substrate 101.

As shown in FIG. 3B, the catalyst layer 102 is next patterned, using, for example, known lithographic etching and/or lift-off techniques. Such patterning can be performed to reduce the number of nanoparticles that are present about the periphery of the catalyst layer 102. For instance, in the example of FIG. 3B, catalyst layer 102 has been patterned to remove several rows of nanoparticles, thus leaving rows 30A-30D. Of course, while four rows of nanoparticles are shown in the example of FIG. 3B for ease of illustration, in actual implementation many more rows of nanoparticles may remain after patterning of the catalyst layer 102.

As shown in FIG. 3C, covering layer 103 is next deposited on the patterned catalyst layer. Such covering layer 103 will cover the top of each remaining row of nanoparticles 30A-30D, and covering layer 103 will fill in the etched-away portions of catalyst layer 102. That is, covering layer 103 will reside on substrate 101 at those areas at which catalyst layer 102 has been etched away. For instance, in the example of FIG. 3C, covering layer 103 resides on substrate 101 in those areas between remaining rows of nanoparticles 30A-30D.

Then, catalyst layer 102 and covering layer 103 are patterned (e.g., etched) into a desired size/shape that is located at a desired location on the surface of substrate 101, which results in the exemplary structure shown in FIG. 3D. As shown in FIG. 3D, covering layer 103 and catalyst layer 102 have been etched such that portions of rows 30B-30D of nanoparticles remain. Of the remaining rows of nanoparticles, various nanoparticles 10 are located at the periphery of the patterned catalyst layer 102, while various nanoparticles 11 are located in an interior region of catalyst layer 102.

The periphery of catalyst layer 102 is not shielded from exposure to a nanostructure growth process, such as CVD or PECVD, while the interior region of catalyst layer 102 is shielded by covering layer 103 from exposure to the nanostructure growth process. In this example, the patterning has resulted in three nanoparticles (labeled 10_{A}, 10_{B}, and 10_{C} in FIG. 3D) exposed on the right periphery 301 of catalyst layer 102 and three nanoparticles exposed on the left periphery 302 of catalyst layer 102, while nine nanoparticles are exposed on the front periphery 303 and rear periphery 304 of catalyst layer 102. Further, in this example, the patterning of catalyst layer 102 prior to deposition of covering layer 103 has spaced the rows of nanoparticles further apart than they were spaced in the originally deposited catalyst layer. Thus, the three nanoparticles exposed on the right and left peripheries 301, 302 of catalyst layer 102 are spaced apart from each other by a desired distance. Accordingly, the patterning in this exemplary fabrication technique both limits the overall number of nanostructures that are grown from catalyst layer 102 (i.e., to growth from nanoparticles about the periphery of such catalyst layer) and controls the spacing of the nanoparticles from which nanostructures are grown.

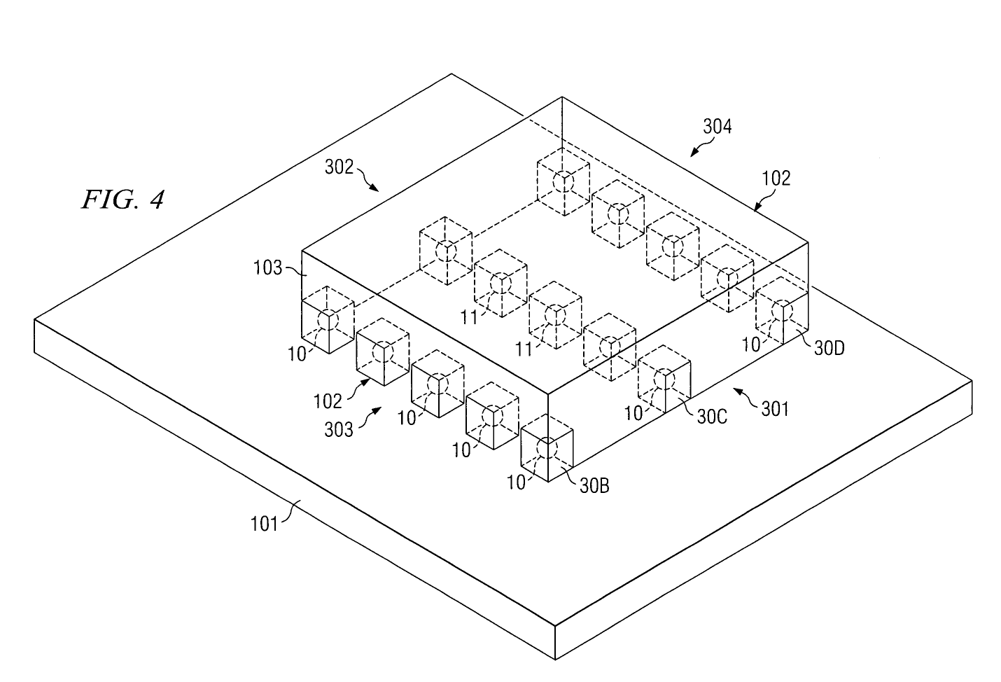

While the exemplary process of FIGS. 3A-3D illustrate patterning the catalyst layer 102 to remove rows of nanoparticles therefrom, in certain embodiments columns of nanoparticles may additionally or alternatively be removed. For example, FIG. 4 shows the exemplary structure of FIG. 3D that results when catalyst layer 102 is patterned to remove both rows and columns (in the etching process of FIG. 3B). Thus, the resulting patterned catalyst layer 102 has five nanoparticles located on its front and rear peripheries 303, 304, rather than the nine nanoparticles that were located on the front and rear peripheries 303, 304 in catalyst layer 102 in FIG. 3D.

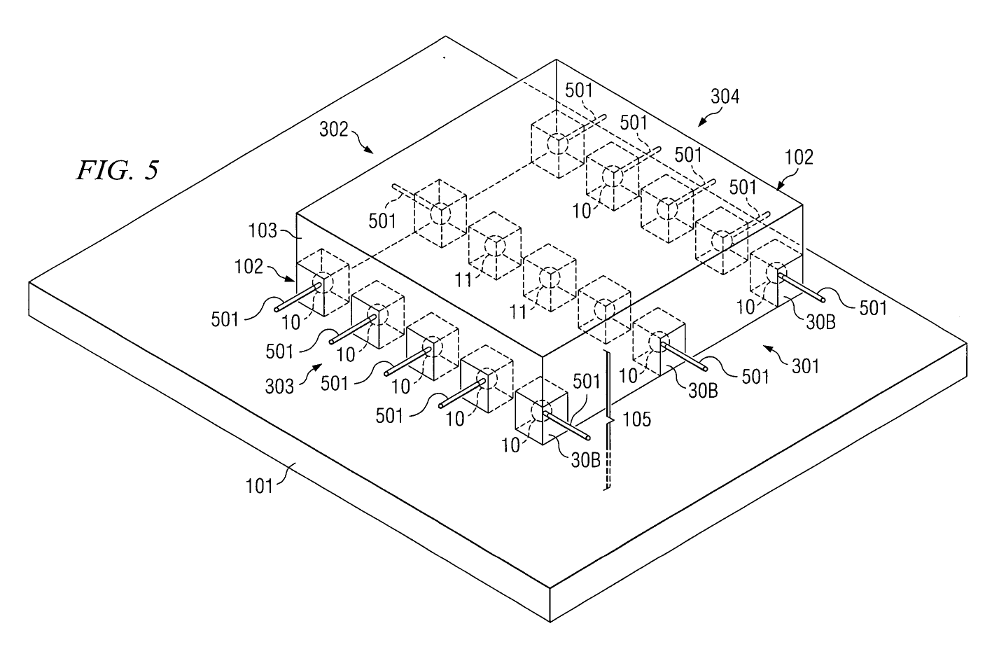

Accordingly, the overall number of nanostructures that are grown from catalyst layer 102 are limited (i.e., to growth from nanoparticles 10 about the periphery of such catalyst layer) and the spacing of the nanoparticles from which nanostructures are grown are controlled by patterning of catalyst layer 102. For instance, FIG. 5 shows the exemplary apparatus of FIG. 4 after it is subjected to a nanostructure growth process. In this illustrated example, nanotubes 501 have grown from nanoparticles 10 about the periphery of catalyst layer 102. Because the catalyst layer 102 is sandwiched between the substrate 101 and the covering layer 103 in sandwich structure 105, growth of nanotubes 501 is limited to growth from nanoparticles 10 located on the periphery of the catalyst layer 102. Further, the overall number and spacing of the grown nanotubes differs from that of FIG. 2. Accordingly, the population and spacing of nanotubes growing from the catalyst layer 102 is further limited over the exemplary apparatus 100 of FIG. 2, which may be desirable for many applications.

In the above examples of FIGS. 1-5, substrate 101 and covering layer 103 may be any materials capable of withstanding the nanostructure growth process to be utilized. The substrate and covering layer materials may be chosen for compatibility with the catalyst system employed for growing nanostructures. For instance, when growing CNTs, the material of substrate 101 and covering layer 103 should be able to withstand typical CNT growth temperatures (600-900C), and such materials that may be utilized in this case include SiO₂, Al₂O₃, polysilicon, or even some refractory metal or a combination of materials, as examples. Catalyst layer 102 may be any catalyst (e.g., thin film structure) now known or later developed for growing desired nanostructures, which may be optimized for the application in mind. For instance, the nickel/alumina thin film catalyst could be extended to nickel/alumina/nickel/alumina or even more layers as dictated by the application.

While exemplary sandwich structures 105 are shown in FIGS. 1-5 above in which a single catalyst layer is included, the concepts described herein may be extended to enable multiple stacked catalyst layers. For instance, after covering layer 103 is deposited onto a first catalyst layer 102, a second catalyst layer may be deposited on top over covering layer 103 (and patterned, if desired) and then another covering layer may be deposited on top of the second catalyst layer. Such deposition of catalyst layers and covering layers may be performed to construct any number of such stacked layers. When exposed to a nanostructure growth process, nanostructures will grow from the periphery of each catalyst layer in such a stacked structure.

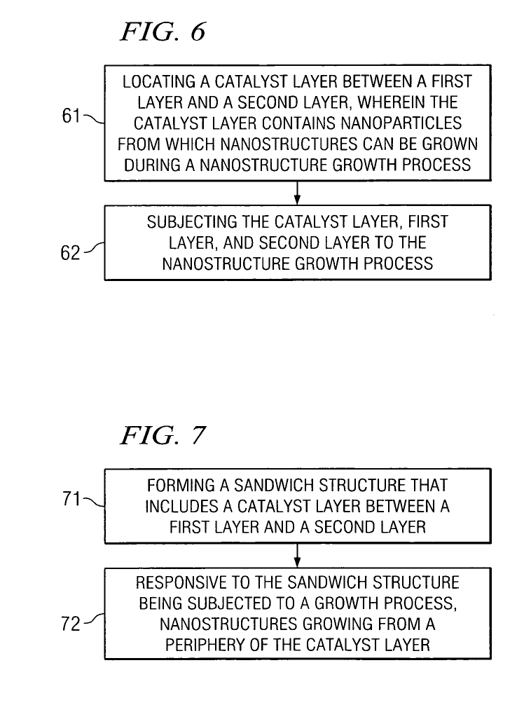

FIG. 6 shows a flow diagram for an exemplary method for limiting the number of nanostructures that are grown from a catalyst layer according to one embodiment of the present invention. In operational block 61, a catalyst layer is located between a first layer (e.g., a substrate 101) and a second layer (e.g., a covering layer 103), wherein the catalyst layer contains nanoparticles from which nanostructures (e.g., nanotubes, etc.) can be grown during a nanostructure growth process (e.g., CVD, PECVD). Exemplary fabrication techniques for so locating a catalyst layer relative to a first and second layer are described above. In operational block 62, the catalyst layer, first layer, and second layer are subjected to the nanostructure growth process. As a result, nanostructures will grow from the periphery of the catalyst layer, but growth will be inhibited from the interior regions of the sandwiched catalyst layer.

FIG. 7 shows a flow diagram for another exemplary method for limiting the number of nanostructures that are grown from a catalyst layer according to one embodiment of the present invention. In operational block 71, a sandwich structure is formed that includes a catalyst layer between a first layer (e.g., a substrate 101) and a second layer (e.g., a covering layer 103). Examples of such sandwich structures are described above. Responsive to the sandwich structure being subjected to a growth process, nanostructures (e.g., nanotubes, etc.) grow from the periphery of the catalyst layer, in block 72. As described above, growth of nanostructures will be inhibited from the interior regions of the sandwiched catalyst layer.

What is claimed is:

1. A method comprising:
locating a catalyst layer between a first layer and a second layer, wherein the catalyst layer contains nanoparticles from which nanostructures grow during a nanostructure growth process; and
subjecting the catalyst layer, first layer, and second layer to the nanostructure growth process.

2. The method of claim 1 further comprising:
responsive to said subjecting, growing nanostructures from said nanoparticles located about a periphery of said catalyst layer.

3. The method of claim 1 further comprising:
during said subjecting, inhibiting by the first and second layers growth of nanostructures from an internal region of the catalyst layer.

4. The method of claim 1 wherein said catalyst layer is a thin film.

5. The method of claim 1 wherein said nanoparticles include nanoparticles selected from Fe, Co, Ni, Pt, Mo, Al, and Al₂O₃.

6. The method of claim 1 wherein said first layer is a material selected from SiO₂, Al₂O₃, MgO, and TiO₂.

7. The method of claim 6 wherein said second layer is a material selected from SiO₂, polysilicon, Al₂O₃, and Si₃N₄.

8. The method of claim 1 wherein said locating comprises:
depositing a thin film that comprises said catalyst layer onto said first layer; and
depositing said second layer onto said thin film.

9. The method of claim 8 wherein said locating further comprises:
patterning said thin film and said second layer.

10. The method of claim 1 wherein said locating comprises:
patterning said catalyst layer and said second layer into a desired shape.

11. The method of claim 1 wherein said subjecting comprises subjecting the catalyst layer, first layer, and second layer to a nanostructure growth process selected from chemical vapor deposition (CVD), and plasma enhanced CVD (PECVD).

12. The method of claim 1 wherein said locating comprises:
locating said catalyst layer on said first layer;
patterning said catalyst layer; and
depositing said second layer on the patterned catalyst layer.

13. The method of claim 12 wherein said locating further comprises:
patterning the second layer.

14. The method of claim 12 wherein said patterning said catalyst layer comprises removing a portion of said nanoparticles such that a periphery of the catalyst layer is less densely populated with said nanoparticles.

15. A method comprising:
forming a sandwich structure comprising a catalyst layer between a first layer and a second layer; and
subjecting the sandwich structure to a nanostructure growth process, said growth process growing nanostructures from a periphery of the catalyst layer.

16. The method of claim 15 wherein said first layer and said second layer inhibit said nanostructures from growing from an internal region of the catalyst layer during said growth process.

17. The method of claim 15 wherein said catalyst layer is located directly on the first layer, and the second layer is located directly on the catalyst layer.

18. The method of claim 15 wherein the catalyst layer is a thin film.

19. The method of claim 15 wherein said forming said sandwich structure comprises:
depositing a thin film that comprises said catalyst layer onto said first layer; and
depositing said second layer onto said thin film.

20. The method of claim 19 wherein said forming said sandwich structure further comprises:
patterning said thin film and said second layer.

21. The method of claim 15 wherein said growth process is one selected from chemical vapor deposition (CVD), and plasma enhanced CVD (PECVD).

22. The method of claim 15 wherein said forming said sandwich structure comprises:
locating said catalyst layer on said first layer;
patterning said catalyst layer; and
depositing said second layer on the patterned catalyst layer.

23. The method of claim 22 wherein said forming said sandwich structure further comprises:
patterning the second layer.

24. The method of claim 22 wherein said patterning said catalyst layer comprises:
removing from said catalyst layer a portion of nanoparticles from which said nanostructures grow during said growth process, thus causing a periphery of the catalyst layer to be less densely populated with said nanoparticles.

25. An apparatus comprising:
a substrate;
a catalyst layer for growing nanostructures; and
a covering layer, wherein prior to said nanostructures growing from said catalyst layer said catalyst layer is located between said substrate and said covering layer.

26. The apparatus of claim 25 wherein said covering layer is arranged such that only a periphery of said catalyst layer is exposed during a nanostructure growth process.

27. The apparatus of claim 25 wherein upon subjecting said apparatus to a nanostructure growth process, nanostructures grow only from a periphery of said catalyst layer.

28. The apparatus of claim 25 wherein said substrate and said covering layer are materials capable of withstanding a nanostructure growth process.

29. An apparatus comprising:
a catalyst layer having a periphery; and
nanostructures extending only from the periphery of the catalyst layer.

30. The apparatus of claim 29 wherein said catalyst layer is sandwiched between a first layer and a second layer during growth of the nanostructures.
